(19) United States
(12) Patent Application Publication
(10) Pub. No.: US 2016/0247086 A1
(43) Pub. Date: Aug. 25, 2016

(54) Method for a system that discovers, locates, indexes, ranks, and clusters multimedia service providers using hierarchical communication topologies

(71) Applicant: Reginald L. Walker, Long Beach, CA (US)

(72) Inventor: Reginald L. Walker, Los Angeles, CA (US)

(73) Assignee: Tapicu Inc., Los Angeles, CA (US)

(21) Appl. No.: 14/999,338

(22) Filed: Apr. 25, 2016

Related U.S. Application Data
(63) Continuation-in-part of application No. 13/135,962, filed on Jul. 19, 2011, now Pat. No. 8,996,427.
Application No. 13/135,962 is a continuation-in-part of application No. 62/178,986, filed on Apr. 24, 2015.

(51) Int. Cl. G06N 7/08; H04L 29/06; G06N 3/12

(52) U.S. Cl. CPC G06N 7/08; G06N 3/126; H04L 65/40

(57) ABSTRACT

A method for discovering, locating, indexing, ranking, and clustering multimedia service providers using hierarchical communication topologies resulting in the retrieval of multimedia files by optimizing parameter sets to efficiently retrieve multimedia files. The method creates a plurity of individual parameter sets, the parameter sets comprising information sharing object parameters for describing structures, search query sets, and dynamic search spaces to be optimized and setting the population of individuals as a population of memes. The parameter sets are initially created using a hierarchical ordering based on the priority and diversity of data transmissions to build and extend individual router tables for a plurity of servers by said client machines.

### CROSS-REFERENCE TO RELATED APPLICATIONS

This application claims benefit of provisional application Ser. No. 62/178,986, filed on Apr. 24, 2015 by the present inventor. This application claims benefit of continuation-in-part of U.S. patent application Ser. No. 13/135,962, filed on Jul. 19, 2011, now U.S. Pat. No. 8,996,427. Each of the above-referenced applications is incorporated herein by reference in their entirety.

### FEDERALLY SPONSORED RESEARCH

Not Applicable

### SEQUENCE LISTING OR PROGRAM

Not Applicable

### BACKGROUND OF THE INVENTION

The invention relates generally to the optimization of object parameters for describing a model, structure, shape, design, process, search query set, and dynamic search space for multimedia resource discovery and retrieval system. In particular, it relates to stochastic optimization search strategies for a multimedia resource discovery and retrieval system for computer information sharing systems such as search engines, data warehouses, and service oriented architectures (SOAs). The multimedia resource discovery and retrieval system uses a plurality of stochastic optimization agents to adaptively solve the network routing problem coupled with one or more information retrieval (IR) problems. The field of evolutionary computation encompasses stochastic optimization techniques, such as randomized search strategies, in the form of evolutionary strategies (ES), evolutionary programming (EP), genetic algorithms (GA), classifier systems, evolvable hardware (EHW), and genetic programming (GP).

There has always been a need to iteratively improve the retrieval of remotely located multimedia files (images, text, audio, and video). The stochastic optimization techniques of evolutionary computation (EC) contain mechanisms which enable the representation of certain unique aspects of individual (agent) behavior to adaptively improve multimedia resource discovery and retrieval mechanisms. Principles of the stochastic optimization techniques of EC can be found for example in Walker (2003) “Tocorime Apicu: Design of an Experimental Search Engine Using an Information Sharing Model”, University of California Dissertation, UMI Dissertation Publishing, Ann Arbor, Mich. 48106-1346 which is incorporated by reference herein in its entirety.

The chief differences among the various types of EC stem from: 1) the representation of solutions (known as individuals in EC), 2) the design of the variation operators (mutation and/or recombination—also known as crossover), and 3) selection mechanisms. A common strength of these optimization approaches lies in the use of hybrid algorithms derived by combining one or more of the evolutionary search methodologies. The underlying optimization methodologies of EC are used to implement unique stochastic aspects of search strategies.

A hybrid of the stochastic optimization techniques of evolutionary computation (EC) provides a computational optimization strategy for problems which are difficult to solve using conventional mathematical techniques, such as the network routing problem coupled with one or more information retrieval problems. They are particularly applied to highly complex situations, where a very large number of variable parameters prevent any formal attempt at a solution. A typical example of such a problem is where a Web crawlers must visit all of the possible number of IP addresses (there are 2³² possible IPv4 addresses) supporting multimedia services and retrieval all text documents—based on the class structures associated with the IPv4 and eventually, the IPv6 protocols (2¹²⁸ or 3.4×10³⁸ possible network addresses). Class A can support up to 2′ (approximately 128) networks, class B can support up to 2′⁴ (approximately 16384) networks, and class C can support up to 2²¹ (approximately 2 million) networks. When the number of sites to be visited is very large, it is not feasible to determine a solution by an exhaustive calculation of the distance for every possible route (this is sometimes referred to as the “traveling salesman” problem).

Information processing associated with the stochastic optimization component of multimedia resource discovery and retrieval systems is hampered by the stochastic information fluctuations that occur each second within the Internet. The multimedia resource discovery and retrieval model encompasses policies and processes that require mechanisms capable of adaptively adjusting operational parameters. These parameters are required to filter, organize, and index any large-scale data set—information stored on a single computer, a local area network (LAN), and a wide area network (WAN) that encompasses the whole Internet—that may consists of constantly fluctuating information content over relatively short periods of time. Additionally, the model (or its individual components) can be applied to hosts of existing multimedia systems that require mechanisms to locate new and updated information in a timely manner, mechanisms to integrate new information into existing knowledge bases, and software to extract, analyze, and disseminate information from large-scale data sets.

Instead, one way of addressing network routing problems is to use stochastic optimization agents that are derive from hybrids of the stochastic optimization techniques of evolutionary computation. According to this approach, sets of different possible routes are selected, each being typically represented in practical implementations by a fixed length string, and the distance for each selected route is calculated (this is known as the “fitness”). Then, a new set of routes is generated by forming essentially random combinations of routes from the preceding set, with those routes having the shortest distances (i.e. best fitness) being preferentially selected for the reproduction of routes for the next generation. The fitness of each member of the new generation is then calculated, and the process is repeated, for example until a predetermined number of generations are reached, or until an individual having a particular fitness level has been produced.

Thus the hybrid stochastic optimization techniques of evolutionary computation mimics natural evolution, in that for each generation, the least successful members are destroyed, and only the most successful members produce progeny for the next generation. In time, it is hoped that the quality of the population steadily improves, eventually leading to an optimal solution. In simplest terms, each cycle of the hybrid stochastic optimization techniques of evolutionary computation involves an evaluation phase for the current population, and then a generation phase, for producing the next generation.

The efficiency of Internet applications is often tested by adding new applications that compete for shared network resources. Studies associated with network traffic show the need for adaptive congestion control and avoidance at the application level. The side-effects resulting from non-adaptive applications include burstiness (degree of self-similarity) in network transmissions. New applications, such as the transmission of multimedia data coupled with current network traffic, provide a hierarchical ordering based on the priority and diversity of data transmissions resulting in periodic optimal one-stage, two-stage, and three-stage neighbor clusters.

The file types associated with multimedia Web transmissions are reduced to images, text, audio, and video. It has been shown that Internet traffic associated with multimedia (text only) file transfers introduced the least network congestion. The addition of image, audio, and/or video transmissions associated with document/file transmissions tends to cause heavy-tailed traffic distributions. The heavy-tailed distributions reflect active/inactive periods and varying sizes of multimedia files. The coupling of information organization with retrieval systems contributes to self-similarity in Internet traffic.

It is the goal of this invention to provide a system and method for reducing the computational effort to achieve periodic optimal multimedia resource discovery and retrieval from a host of diverse multimedia sources.

### BACKGROUND OF THE INVENTION

### Objectives

Accordingly, the objectives and advantages of the invention are as follows:

It is an objective of the present invention to use stochastic optimization agents formed from hybrid algorithms derived by combining one or more of the evolutionary computation search methodologies.

It is another objective of the present invention to encompass policies and processes that require mechanisms capable of adaptively adjusting operational parameters required to filter, organize, and index any large-scale data set—information stored on a single computer, a local area network (LAN), and a wide area network (WAN)—that may consists of constantly fluctuating information content over relatively short periods of time.

It is another objective of the present invention to represent solutions as memes to reduce in the computational effort to achieve the periodic optimal document clusters. The fitness of a species can be improved by the non-genetic transmission of cultural information that uses a meme as the transmission mechanism rather than the genetically based gene. The difference between the two includes the fact that genetic transmissions (stochastic selection process) evolve over a period of generations, whereas cultural transmissions result from an educational process.

It is another objective of the present invent to continuously apply algorithm control parameters to improve the discovery, locating, indexing, ranking, and clustering of multimedia service providers in distributive applications leading to hierarchical ordering based on the priority and diversity of data transmissions resulting in periodic optimal one-stage, two-stage, three-stage, and four-stage neighbor clusters.

### SUMMARY OF THE INVENTION

The invention is a system and methods for discovering, locating, indexing, ranking, and clustering multimedia service providers using hybrid search strategies and the stochastic optimization techniques of evolutionary computation (EC) by using a hierarchical ordering based on the priority and diversity of data transmissions to build and extend individual router tables in order to derive one-stage, two-stage, and three-stage neighbor clusters. These stochastic optimization techniques form the basis of a regulatory mechanism for sharing information document clustering and ranking which leads to the migration of multimedia files between multimedia indexers. The iterative application of these mechanisms improves the subclustering of multimedia files in distributive applications leading to disjoint nodes for chosen sets of search queries.

According to the invention there is provided a multimedia resource discovery and retrieval system comprising:
a. Decentralized retrieval of multimedia files located throughout a local area network (LAN), and a wide area network (WAN) combine adaptive solutions achieved by the various the stochastic optimization agents of multimedia resource discovery and retrieval system to the network routing problem coupled with one or more information retrieval problems. The objectives are to achieved: 1) maximization of resource utilization and of overall LAN throughput, and 2) minimization of rejected request packets and guarantee quality of service (QoS). The network routing procedure requires shortest path routing that minimizes “hops” between the source and randomly chosen Internet service providers (ISPs). Factors that must be considered are connection requirements (end-to-end delay, delay variation, mean rate) and network conditions, and
b. Real-time system constraints that require timeliness and correctness of periodic tasks, sporadic tasks, and aperiodic tasks executed by the stochastic optimization agents. The periodic tasks are those with fixed time requirements, sporadic tasks are governed by some minimum inter-arrival time, and aperiodic tasks are governed by some stochastic assumptions. Generally, skip-over scheduling is applied to all these tasks since the Internet's workload fluctuates. The skip-over policy defers those jobs which jeopardize the new job's deadlines. These deferred jobs are placed at the end of the scheduling queue in order to reassess the stochastic optimization parameters of optimization agents in order to meet the QoS requirements. The stochastic optimization search and retrieval strategies require that QoS and quality of information sharing be maintained for each ISP hosting multimedia services in order to efficiently retrieve multimedia files.
c. Information sharing between two or more stochastic optimization agents has two advantageous effects on the behavior of aggregate memes: each meme has more environmental information than a solitary meme, and each stochastic optimization agent pays less for the information. The benefits of information sharing among stochastic optimization agents include a reduction in environmental discovery and measurement cost, which leads to more relevant and/or timely information associated with each meme. Such combining of cost benefits leads to a collective capable of adapting to constantly changing ecosystems. Each collective may be the result of a division of labor or a hierarchical communication topology.

### DETAILED DESCRIPTION OF THE DRAWINGS

### Figures

FIG. 1 is a diagram showing application layer portion of the software architecture of the present invention.

FIG. 2 is a block diagram of the multimedia resource discovery and retrieval system embodying the invention.

FIG. 3 is a diagram showing communication topologies for hierarchical ordering based on the priority and diversity of data transmissions to build and extend individual router tables.

FIG. 4 is a diagram showing the interactions of the one-stage, two-stage, three-stage, and four-stage neighbors to form hierarchical neighbor clusters.

### DETAILED DESCRIPTION

### Preferred Embodiments

A preferred embodiment of the present invention is now described with reference to the figures where like reference numbers indicate identical or functionally similar elements.

Some portions of the detailed descriptions that follow are presented in terms of stochastic optimization agents which can be implemented by those skilled in data processing art to most effectively convey the substance of their work to others skilled in the art. It should be noted that the stochastic optimization agents of the present invention could be embodied in software, could be downloaded to reside on and be operated from different platforms used by a variety of operating systems.

The present invention also relates to an apparatus for performing the operations herein. This apparatus may be specially constructed for the required purposes, or it may comprise a general-purpose computer selectively activated or reconfigured by a computer program stored in a computer. Furthermore, the computers referred to in the specifications may include a single processor or may be architectures employing multiple processor designs for increased computing capability.

The stochastic optimization agents presented herein are not inherently related o any particular computer of other apparatus. Various general-purpose systems may also be used with programs in accordance with the teaching herein, or it may prove convenient to construct more specialized apparatus. The required structure for a variety of these systems will appear from the description below. In addition, the present invention is not described with reference to any programming language. It will be appreciated that a variety of programming languages may be used to implement the teachings of the present invention as describe herein, and any references below to specific languages are provided for disclosure of enablement and best mode of the present invention.

Accordingly, the disclosure of the present invention is intended to be illustrative, but not limiting, of the scope of the invention, which is set forth in the claims.

### 1. Notational Conventions

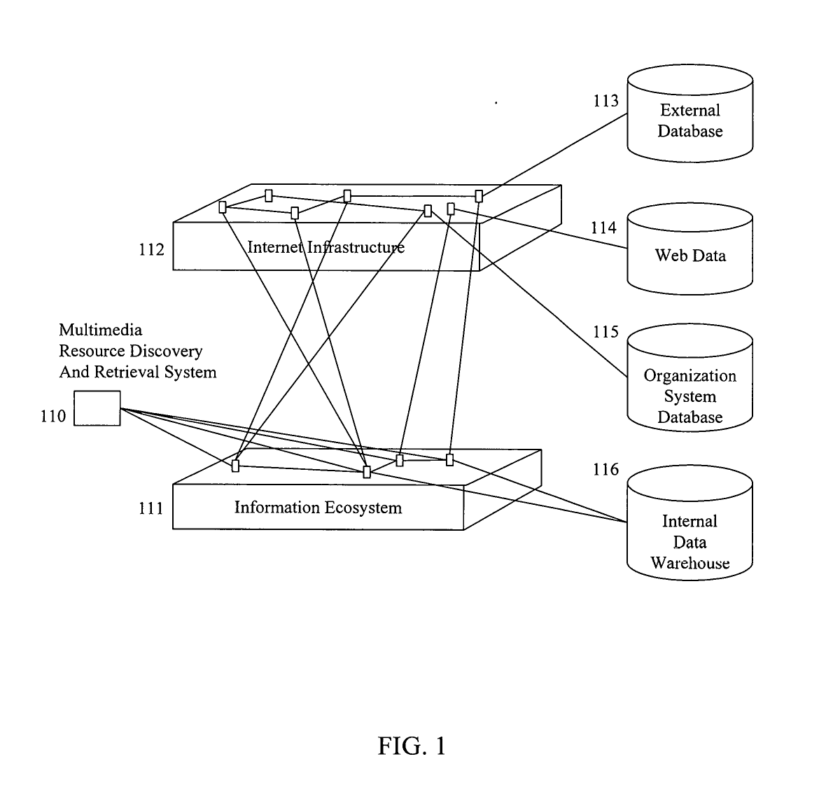

FIG. 1 provides an overview of the processing completed by the stochastic optimization agents of the multimedia resource discovery and retrieval system. Processing starts in this system 110 when the data extraction portion of the stochastic optimization component extract multimedia files from a mapping of an information ecosystem 111 to selected areas of the network structure of the Internet infrastructure 112 which provides access to external databases 113, Web data 114, organization system databases 115, or internal data warehouses 116.

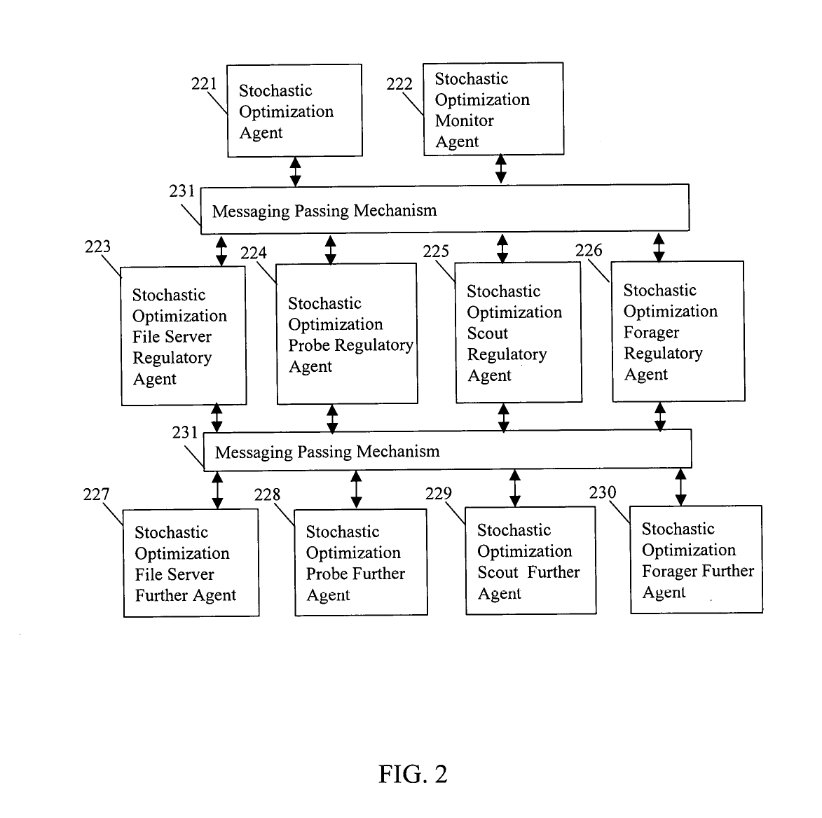

FIG. 2 presents the adaptive stochastic optimization agents 221-230 for the stochastic optimization component of multimedia resource discovery and retrieval system based on the information discovery model. This model has built-in mechanisms that allow each stochastic optimization agent to adapt its operational parameters to a changing environment. The stochastic optimization agents 221-230 are applied to the ever-changing environment of local area network (LAN) and/or a wide area network (WAN) traffic which varies considerably, depending on: 1) time of day, 2) time zones, 3) various holiday and/or vacation patterns that exist throughout the world, and 4) naturally occurring disasters. The stochastic optimization further agents 228-230 communicate via message passing mechanisms 231,232, and emulate stochastic optimization information search strategies for: locating forage sources, and detecting and avoiding foraging congestion.

Stochastic optimization probe further agents 228 are deployed throughout the information ecosystem 111 in search of ISPs hosting multimedia services in order to initiate the development of customized routes for the retrieval of multimedia files by stochastic optimization forager further agents 230. Stochastic optimization scout further agents 229 use information obtained by the stochastic optimization probe further agents 228 to detect network congestion. The various objectives just mentioned are monitored by the stochastic optimization agents 221,222 and stochastic optimization regulatory agents 223-226 using rescaled adjusted range (RS) statistics.

The stochastic optimization agents 221,222 focus on performance monitoring of the interaction between stochastic optimization regulatory agents 223-226. The stochastic optimization probe agents 224,228 and stochastic optimization forager agents 225,229 form crucial components of the stochastic optimization component of the multimedia resource discovery and retrieval systems. Each located ISP is identified as useful by stochastic optimization probe regulatory agents 224 if it provides the desired multimedia services. These marked sites are provided to the stochastic optimization scout regulatory agent 225. The stochastic optimization probe further agents 228 are not concerned with network congestion or any other aspect of file retrieval. The stochastic optimization scout regulatory agents 225 proceed with the site metrics provided by only its group stochastic optimization probe regulatory agents 224. Stochastic optimization scout further agents 229 are released to each selected site periodically to gather and update information ecosystem 111 congestion traffic metrics. The stochastic optimization scout regulatory agent 225 use these metrics on a per-site basis to determine the feasibility of retrieving multimedia files from a selected site. Site rankings are based on the results of the feasibility tests which use RS statistics to perform time series analysis on each site's congestion metrics. The feasibility results for each site vary based on the time of day, time zone location with respect to the location of the stochastic optimization agents of multimedia resource discovery and retrieval system, localized holiday and vacation patterns, and natural disasters. The periodic feasibility update of each site occurs within a random time period and is based on the workload of each stochastic optimization scout regulatory agent 225 and stochastic optimization forager regulatory agent 226 coupled with the update rate of the newly located sites provided by its corresponding stochastic optimization probe regulatory agents 224.

The stochastic optimization regulatory agents 223-226 contain those features essential for releasing and coordinating the stochastic optimization further agents 227-230. Each stochastic optimization regulatory agents 223-226 has a finite scope, limiting its activity to those ISPs inscribed within an area whose radius is given by a value V (its visibility).

The stochastic optimization probe regulatory agent 224 provide stochastic optimization scout regulatory agent 225 with results in the form of IP addresses reflecting initial visits to random ISPs. The stochastic optimization scout regulatory agent 225 uses the IP address of the appropriate ISP in order to start the process of determining/charting the optimal (customized) route using RS statistics. The stochastic optimization forager regulatory agent 226 uses the selected IP address if the RS statistics indicate that the corresponding information server meets the required QoS. This methodology has the ability to discover new ISPs as well as new sub-hosts, thus providing services to both new and existing information clients—this in turn resulting in faster discovery of new and updated documents. Each stochastic optimization further agent 227-230 is:
1. Reactive—can interact with the information ecosystem 111 within appropriate time limits
2. Independent—can act on its own
3. Robust—can cope with the ever-changing network environment within the information ecosystem
   The efficiency of the stochastic optimization forager further agents 230 is due to customized ISP router tables which are discovered by the stochastic optimization scout further agents 229—the result of periodic searches for optimized routes that exist for short periods of time. The initial step in this methodology is the releasing of stochastic optimization probe further agents 228 for all ISPs in a manner similar to reliable flooding.

The rapid release of a series of stochastic optimization further agents (probe/scout/forager sets 228-230) can have an adverse affect on the receiving host (ISP server) as well as on the releasing stochastic optimization regulatory agent 224-226. Each stochastic optimization regulatory agent 223-226 creates a series of stochastic optimization further agents 227-230 which can exhaust the resources of the system resources allocated to the stochastic optimization regulatory agent 223-226. The stochastic optimization further agents 228-230 are most effective in the event/case of reliable flooding, where monitoring stochastic optimization agents 221,222 and stochastic optimization regulatory agents 224-226 are used to adequately control and coordinate valuable information returned by each individual process. The ISP hosting multimedia services may interpret the simultaneous requests as a form of flooding, resulting in requests being queued at the router level and/or server level. In the worst-case scenario, the life-span of a stochastic optimization further agent 228-230 will exceed the amount of time needed to establish communication with the selected ISP and retrieve the requested information. Attempts to avoid worst-case scenarios are made through the use of RS statistics provided by the stochastic optimization scout further agents 229.

The stochastic optimization regulatory agents 223-226 needed for retrieving multimedia files require some form of adaptive methodology since each stochastic optimization further agent 227-230 searches for efficient paths (routes) to an uncongested source of information (documents) in order to build the stochastic optimization component of multimedia resource discovery and retrieval system ISP router tables.

The stochastic optimization forager regulatory agent 226 receives input from the stochastic optimization scout regulatory agent 225 which makes retrieval decisions based on the conversion of congestion detection information into high-level congestion avoidance mechanisms before releasing stochastic optimization forager further agents 230. The release of stochastic optimization forager further agents 230 can only occur if the stochastic optimization scout regulatory agent 225 indicates that the feasibility results pass the QoS requirements imposed by the stochastic optimization component of multimedia resource discovery and retrieval systems. This layer of congestion avoidance incorporates network metrics from mechanisms used to customize routes between the location of the stochastic optimization component of multimedia resource discovery and retrieval systems and each selected ISP. Snapshots of source/destination traffic flow can change drastically over relatively short periods of time—depending on the release and return of each stochastic optimization scout further agents 229. The second layer of congestion avoidance is handled implicitly by information ecosystem and Internet routers and switches 111,112 between the source 110 and destination 113,114,115,116.

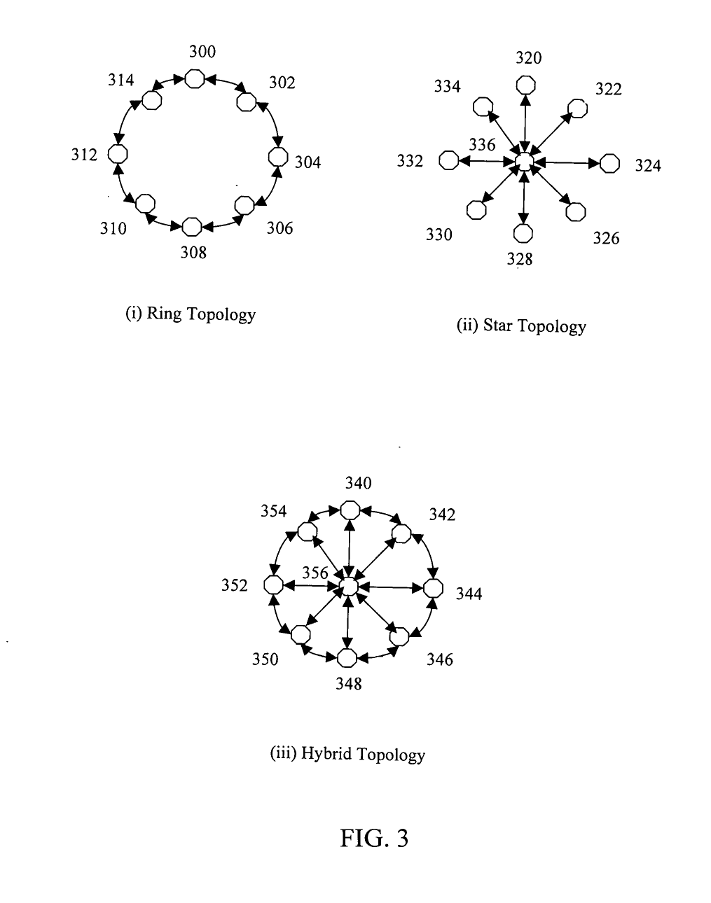

FIG. 3 presents the communication topologies used to build and extend individual router tables. The communication topologies consists of i) a ring communication topology 300,302,304,306,308,310,312,314, ii) star communication topology 320,322, 324,326,328,330,332,334,336, and iii) hybrid communication topology 340,342,344,346, 348,350,352,354,356.

Neighbor clustering associated with discovering multimedia service providers comprises randomly selecting a first meme 300,302,304,306,308,310,312,314,320,322, 324,326,328,330,332,334,336,340,342,344,346,348,350,352,354,356, and selecting a second meme 300,302,304,306,308,310,312,314,320,322,324,326,328,330, 332,334, 336,340,342,344,346,348,350,352,354,356 by increasing an ID of the first meme, thereby mimicking the ring communication, star communication, or hybrid communication topologies using a hierarchical ordering based on the priority and diversity of data transmissions to build individual router tables and determine adjacent memes.

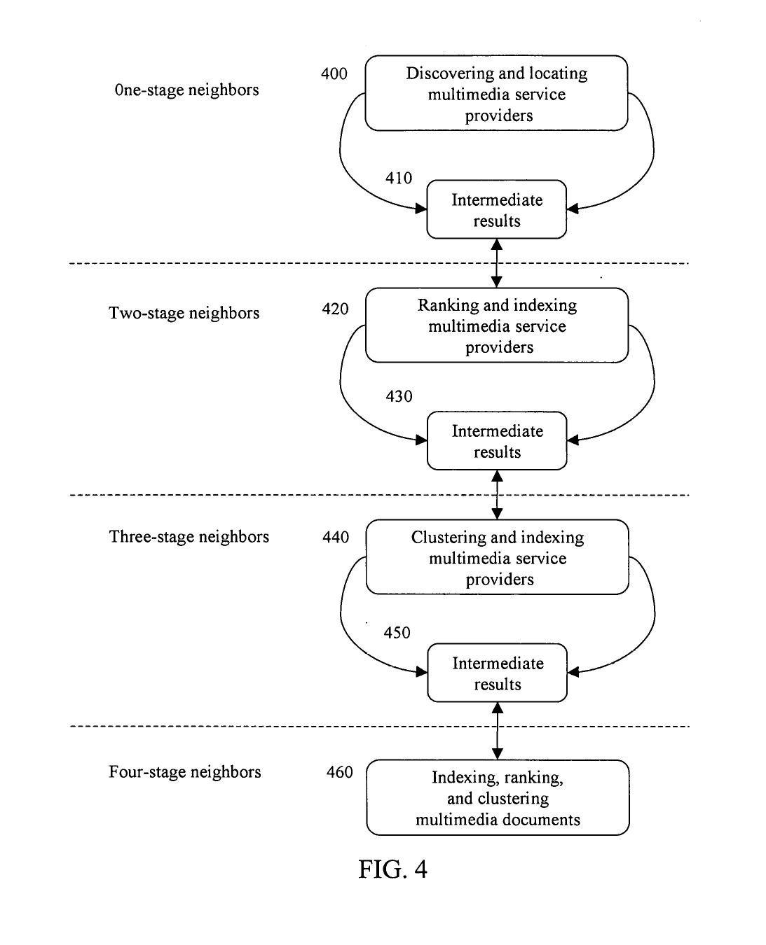

FIG. 4 presents the multi-stochastic optimization agent 221-230 approach that modifies search-for-service strategies by incorporating hierarchical communication topologies into the structure of meme compositions—division of labor—to implement the model which focuses on locating 400, indexing 420,440,460, ranking 420,440,460, and clustering 420,440,460 multimedia service providers within the information ecosystem 111. The partition of labor into one-stage neighbors 400, two-stage neighbors 420, three-stage neighbors 440, and four-stage neighbors 460 forms adaptive neighborhood clusters consisting of stochastic optimization agents selected from one-stage neighbors 400, two-stage neighbors 420, three-stage neighbors 440, and four-stage neighbors 460 neighbor partitions to build a multimedia file warehouse. The stochastic optimization agents that forms a hierarchical communication topology neighbor clusters uses network communication strategies—i) a ring communication topology 300,302,304,306,308,310,312,314, ii) star communication topology 320,322, 324,326,328,330,332,334,336, and iii) hybrid communication topology 340,342,344,346, 348,350,352,354,356—to communicate Internet congestion detection and avoidance results as well as intermediate results 410,430,450, this hierarchical ordering based on the priority and diversity of data transmission to build and extend individual router tables for each multimedia service provider hosting multimedia services forming the basis of memes.

I claim:

1. A method for discovering, locating, indexing, ranking, and clustering multimedia service providers using hierarchical communication topologies by applying distributed stochastic optimization techniques of evolutionary computation using a plurality of servers and a plurality of clients machines being connected via a computer network, said stochastic optimization techniques of evolutionary computation aiming to optimize a population of individuals against one or more predetermined fitness criteria, wherein the computer code instructions are invoked by stochastic optimization agents; said method for applying distributed stochastic optimization techniques of evolutionary computation including the steps of:
creating an initial population of a plurity of individuals parameter sets by using a hierarchical ordering based on the priority and diversity of data transmissions to build and extend individual router tables comprising of information sharing system object parameters for describing a model, structure, shape, design, process, search query set, and dynamic search space to be optimized;
setting the initiating population as a population of memes, transmitting by a population of memes, cultural information resulting from an educational process;
transmitting cultural information comprises formulating the population of memes into hierarchical neighbor clusters by one of the steps consisting of one-stage neighbor clusters, two-stage neighbor clusters, three-stage neighbor clusters, or four-stage neighbor clusters using the hierarchical ordering based on the priority and diversity of data transmissions for each individual router tables for a plurity of servers by said client machines wherein:
formulating one-stage neighbor clustering associated with discovering multimedia service providers comprises randomly selecting a first meme, and selecting a second meme by increasing an ID of the first meme, thereby mimicking the ring communication, star communication, or hybrid communication topologies based on the hierarchical rank in order to build individual router tables and determine adjacent memes;
formulating two-stage neighbor clustering associated with requesting multimedia services comprises the coupling of the discovery step with the requesting step resulting in extending individual router tables with QoS statistics where one or more memes are selected using proportional fitness selection, roulette wheel selection, or tournament selection;
formulating three-stage neighbor clustering associated with retrieving multimedia files comprises using the extended individual router tables to request and retrieve a multimedia file and create its corresponding meme;
formulating four-stage neighbor clustering associated with indexing, ranking, and clustering memes by optimizing parameter sets consisting of object parameters containing one or more multimedia files;
generating two-stage, three-stage, and four-stage neighbor clusters until no three-stage neighbor clusters of two or more memes are found; and
repeating all steps until achieving periodic optimal one-stage, two-stage, and three-stage neighbor clusters.

2. The method of claim 1 wherein the indexing, ranking, and clustering of the each object parameter of the parameter set, forms the basis of cultural information transmission, leading to the migration of individual router tables between memes.

3. The method of claim 2 wherein the object parameters of the parameter set of the first selected meme, member of one-stage neighbor clusters, regulates cultural transmissions between selected memes.

4. The method of claim 1 wherein the transmission of cultural information between memes, resulting in parameter set variance, leads to variances in the object parameters for describing the meme to be optimized.

5. The method of claim 1 wherein the selection process for one-stage neighbor clusters, randomly selects one meme, is nondeterministic as a result of the composition of the object parameters in the parameter set that describe each meme.

6. The method of claim 1 wherein the first randomly selected meme, resulting in the emergence of subclustering, regulates the cultural transmission rate between two-stage, three-stage, and four-stage neighbor clusters.

7. The method of claim 6 wherein the transmission of cultural information between one-stage, two-stage, and three-stage neighbor clusters, resulting in population variance, leads to variances in the object parameters, for describing the model, structure, shape, design, process, search query set, and dynamic search space to be optimized.

8. The method of claim 6 wherein said parameter sets are iteratively improved, as a population of memes, evolving clusters of competing object parameters over a dynamic search space.

9. The method of claim 1 for optimizing the shape of the dynamic search space enhances the quality of the one-stage, two-stage, three-stage, and four-stage neighbor cluster solution spaces, allowing for continuous updates and redistribution of individual router tables.

10. A system for discovering, locating, indexing, ranking, and clustering multimedia service providers using hierarchical communication topologies by applying distributed stochastic optimization techniques of evolutionary computation using a plurality of servers and a plurality of clients machines being connected via a computer network, said stochastic optimization techniques of evolutionary computation aiming to optimize a population of individuals against one or more predetermined fitness criteria, wherein the computer code instructions are invoked by stochastic optimization agents; said method for applying distributed stochastic optimization techniques of evolutionary computation including the steps of:
creating an initial population of memes by using hierarchical ordering based on the priority and diversity of data transmissions to build and extend individual router tables, the parameter sets comprising information sharing system object parameters for describing a model, structure, shape, design, process, search query set, and dynamic search space to be optimized;
transmitting by the population of memes, cultural information resulting from an educational process; generating one-stage, two-stage, and three-stage neighbor clusters until no multi-stage neighbor clusters of two or more memes are found; and
repeating all steps until achieving periodic optimal meme clusters.

11. The system of claim 10 wherein discovering, locating, indexing, ranking, and clustering of multimedia service providers using hierarchical communication topologies associated with each meme resulting in the retrieval of multimedia files, forms the basis of cultural information transmission, leading to the migration of individual router tables between memes.

12. The system of claim 10 wherein the first selected meme, member of one-stage neighbor clusters, regulates cultural transmissions between selected memes.

13. The system of claim 10 wherein the transmission of cultural information between memes, resulting in parameter set variance, leads to variances in the object parameters for describing the meme to be optimized.

14. The system of claim 10 wherein the selection process to for one-stage neighbor clusters, randomly selects one meme, is nondeterministic as a result of the composition of the object parameters in the parameter set that describe each meme.

15. The system of claim 10 wherein the first randomly selected meme, resulting in the emergence of subclustering, regulates the cultural transmission rate between one-stage, two-stage, and three-stage neighbor clusters.
